(19) United States
(12) Patent Application Publication
(10) Pub. No.: US 2004/0147261 A1
(43) Pub. Date: Jul. 29, 2004

(54) Method for providing presence display data

(76) Inventor: Marc Roelands, Mortsel (BE)

Correspondence Address: MORRISON & FOERSTER LLP, 1650 TYSONS BOULEVARD, SUITE 300, MCLEAN, VA, 22102, US

(21) Appl. No.: 10/651,080

(22) Filed: Aug. 29, 2003

(30) Foreign Application Priority Data
Sep. 2, 2002 (DE) 10241092.5

(51) Int. Cl. H04Q 7/20; H04B 1/16; G09G 5/00

(52) U.S. Cl. 455/432.3; 345/745; 455/415; 455/229

(57) ABSTRACT

The invention relates to a method for providing presence display data (PAD1), which is associated with a user (NU1) for display on a communications terminal (KEG1), in which presence data (PD) which relates to at least one preselected subscriber is stored such that it can be accessed by a presence computer (PR), the presence display data (PAD1) is produced with the presence data (PD) being processed on the basis of a processing instruction (V1) which is associated with the user (NU1), and the presence display data (PAD1) is stored in a display store (AS).

### CLAIM FOR PRIORITY

This application claims priority to Application No. 10241092.5 which was filed in the German language on Sep. 2, 2002.

The invention relates to a method for providing the presence display data for display on a communications terminal.

The document 3GPP TS 23.141 V0.0.0. “3rd Generation Partnership Project; Technical Specification Group Services and System Aspects; Presence Service; Architecture and Functional Description (Release 6)” dated June 2002 describes a service which is referred to as a “Presence service” in which a presence computer (presence server) is used to monitor characteristics of selected communication subscribers. These characteristics include, for example, the respective current accessibility by telephone, by written short messages (SMS) or by e-mail. Information about such characteristics is collected by the presence computer and is stored in the form of presence data. The presence display data is selected from the presence data on the basis of the association of the service user with blocking lists, personal access lists or general access lists, and this presence display data is transmitted to a communications terminal for the service user.

The invention is based on the object of specifying a method which can be used in a versatile manner for provision of presence display data.

According to the invention, this object is achieved by a method for providing presence display data, which is associated with a user for display on a communications terminal, in which presence data which relates to at least one preselected subscriber is stored such that it can be accessed by a presence computer, the presence display data is produced with the presence data being processed on the basis of a processing instruction which is associated with the user, and the presence display data is stored in a display store, as a result of which the presence display data can be transmitted to the communications terminal immediately after being read from the display store when a check is made at the communications terminal end. In this case, it is particularly advantageous that the processing instruction which is associated with the user can be used to provide presence display data which is individually matched to the user can thus, for example, be matched to customized features in the user's communications terminal. Furthermore, appropriate refinement of the processing instructions can be used to satisfy a data protection requirement for the subscriber, since only the processed presence display data is displayed to the user by the communications terminal, but not the original presence data. A further particularly advantageous feature is that the completely produced presence display data is stored in the display store so that the transmission of the data can be started quickly when the user uses the communications terminal to request the presence display data. This is particularly advantageous when the processing of the presence data is time-consuming.

The method can be carried out in such a way that the processing comprises the transfer of selected presence data to the presence display data.

The method according to the invention can also be carried out such that the processing comprises changing the selected presence data and transferring the changed presence data to the presence display data. In this case, the presence data for an appropriate processing instruction can advantageous be changed before it is stored as presence display data. This allows the presence display data to be adapted such that, for example, this avoids storage of data which is unsuitable or is not advantageous for display on the communications terminal.

The method according to the invention can also be carried out such that the presence data is changed by comparing the presence data with collected presence data that is stored in a database and, if the comparison result is positive (for example if the presence data matches the collected presence data), by using allocation data which is associated with the collected presence data as the changed presence data.

In this case, the presence data can be compared with the collected presence data in order to produce a classification or association of the presence data for higher-level data complexes. This advantageously makes it possible, for example, to replace a large amount of presence data by a small amount of allocation data. This makes it possible to considerably reduce the complexity for storage of the presence display data in the display store, for transmission of the presence display data to the communications terminal, and for display on this communications terminal, thus reducing the load both on the presence computer and on the communications terminal, as well as on a communications network which connects the presence computer to the communications terminal.

The method according to the invention can also be carried out such that the presence data is changed by inverting presence data which is in binary form, and by using the inverted presence data as the changed presence data.

The method according to the invention can also be carried out such that the presence data is changed by replacing the presence data by predetermined presence data, and by using the predetermined presence data as the changed presence data. When using the two last-mentioned refinements of the method according to the invention, the true presence data can advantageously be concealed from the service user; this makes it possible to provide protection for the subscriber's private sphere.

The method according to the invention can also be configured such that the presence display data is produced when a change occurs to the presence data which is stored for the presence computer. The method according to the invention can also be configured such that the presence display data is produced when a change occurs to the processing instructions which are stored in an instruction store. These method refinements advantageously mean that up to date presence display data is always available in the display store and can be transmitted quickly to the communications terminal when requested.

The method according to the invention can also be carried out such that two or more different presence display data items are produced on the basis of two or more processing instructions, with each of these processing instructions being associated with one user, and these two or more presence display data items being stored in the display store. This makes it possible to store presence display data for a large number of method users, from which a data call may be expected in the future, in a state in the display store such that this data is ready to be transmitted.

The method can also be carried out such that various processing instructions for a user are stored in the instruction store, and the single processing instruction which is currently to be used is determined from these various processing instructions by comparing identifiers which are in each case different and are associated with the various processing instructions with a subscriber identifier which is available in the process computer and describes a currently applicable subscriber status of that subscriber. This makes it possible to use different processing instructions depending on the situation, so that different presence display data can be provided for the users, depending on the status of the subscriber. This makes it possible to provide an extraordinarily flexible method.

The method can also be carried out such that the subscriber identifier is received at the presence computer end by a presence communication terminal of the subscriber, and the subscriber identifier can be entered on the presence communication terminal. This refinement of the invention allows the subscriber identifier to be determined in particularly simple manner at the presence computer end.

The method can also be carried out such that the subscriber identifier is determined by the presence computer by monitoring a predetermined presence data item for a predetermined change, and by identifying the presence of the subscriber identifier when this change occurs. In this refinement of the method according to the invention, the subscriber identifier can advantageously be determined automatically on the basis of the occurrence of changes to predetermined presence data items. Changes such as these can thus preferably be used to determine the current status of the subscriber, and hence his or her subscriber identifier.

The method according to the invention can also be configured such that, once the presence computer has determined the subscriber identifier, presence data which is associated with that subscriber identifier is changed, in response to which the presence display data is produced once again. This advantageously makes it possible to change the presence data when the status and hence the subscriber identifier of the subscriber has changed, so that these dynamic changes lead directly to matched and up-to-date presence data.

In order to explain the method according to the invention further,

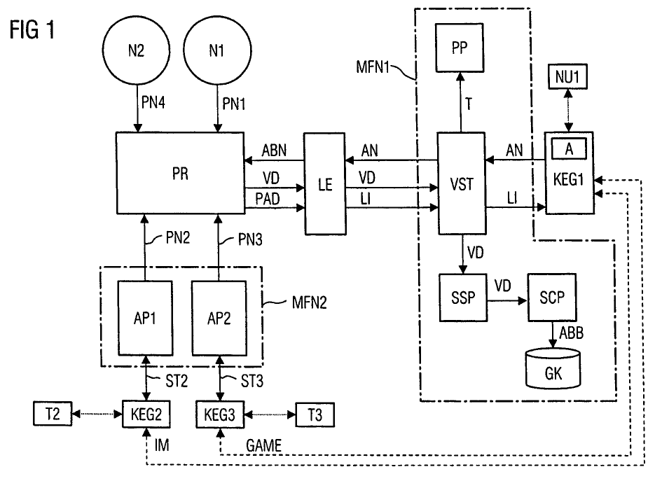

FIG. 1 shows a schematic illustration of one exemplary embodiment of the method according to the invention,

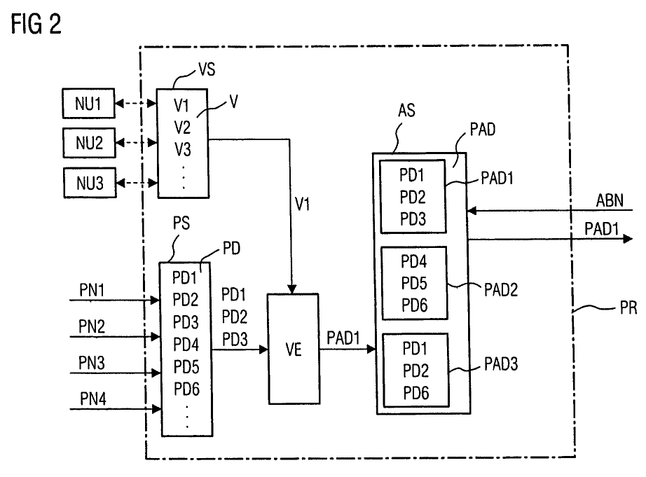

FIG. 2 shows a schematic illustration of one exemplary embodiment of the method steps which are carried out in a presence computer,

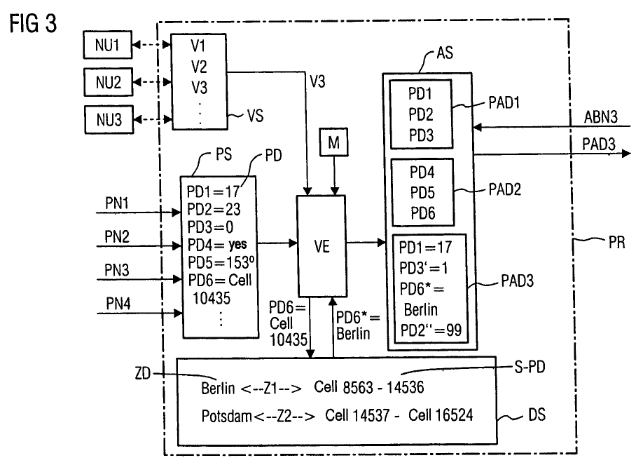

FIG. 3 shows a schematic illustration of a further exemplary embodiment of the method steps which are carried out in the presence computer,

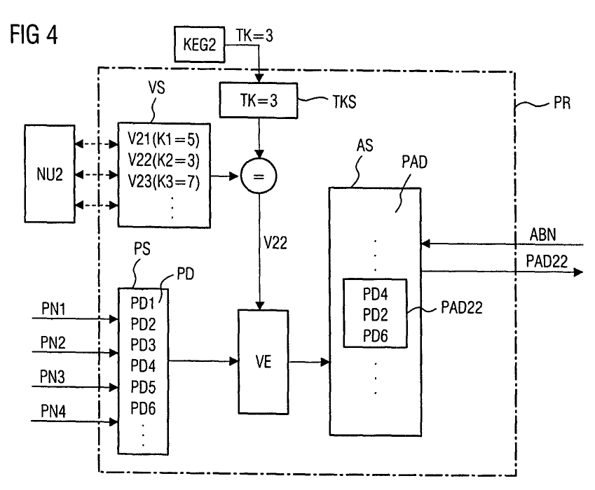

FIG. 4 shows a schematic illustration of a further exemplary embodiment of the method steps which are carried out in a presence computer, and

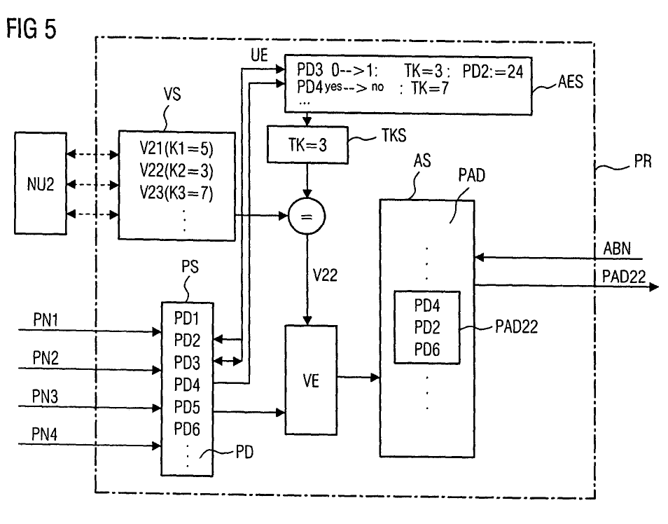

FIG. 5 shows a schematic illustration of a further exemplary embodiment of method steps which are carried out in the presence computer.

A communications terminal KEG1 with a display A and which is associated with the user NU1 of a presence service is shown on the right-hand side in FIG. 1. This communications terminal KEG1 and further communications terminals which are mentioned in the following text as well may, for example, be in the form of a mobile telephone, a palm top, a portable computer or a personal computer with a mobile radio interface. The communications terminal KEG1 is connected to a list generating device LE via a mobile radio network MFN1. Only one switching center VST, a charge invoicing device PP (Post Processing charging device), a service switching point SSP, a service control point SCP and a credit account GK are shown in the mobile radio network MFN1.

When the first communications terminal KEG1 requires information about further communications terminals or about subscribers who are using these further communications terminals (for example information about the further communications terminal KEG2 or KEG3 which are described further below or about subscribers T2 or T3 who are associated with these further communications terminals), than the first communications terminal KEG1 sends a request message AN via the switching center VST to the list generating device LE. This request message AN contains the information that the first communications terminal KEG1 requires presence information relating to the further communications terminals mentioned above, or to their subscribers. After receiving the request message AN, the list generating device LE generate a call message ABN and sends this call message to a presence computer PR, as a result of which this presence information is called up from the presence computer PR.

Such presence computers PR are known per se and are described, for example, in the document cited initially. The presence computer PR monitors people and their communications terminals (in the example the further communications terminals KEG2 and KEG3) and collects presence data relating to these people and further communications terminals, and/or has the presence data sent to it.

In this exemplary embodiment, presence messages PN1 to PN4 which are provided with presence data reach the presence computer. The presence data which is transmitted with the presence message PN1 originates from a second generation mobile radio network N1 (that is to say, for example, from a mobile radio network which is operating in accordance with the GSM Standard (GSM=Global System for Mobile Communication). Presence data such as this may, for example, include the information as to which —not shown in FIG. 1—further communications terminals are currently registered (logged on) in the mobile radio network N1, or to which further communications terminals mobile radio links can currently be set up via the network N1. The presence data in the presence message PN4 originates from a third generation mobile radio network N2, that is to say by way of example from a mobile radio network which is operating in accordance with a UMTS Standard (UMTS=Universal Mobile Telecommunications System) or in accordance with the GPRS Standard (GPRS=General Packet Radio Service). This presence data which is transmitted by means of the presence message PN4 may, for example, include the information as to which further communications terminals are currently accessible via the mobile radio network N2.

The further communications terminals KEG2 and KEG3 (which may also be referred to as presence communications terminals KEG2 and KEG3 since they provide presence information relating to subscribers T2 and T3) are connected to the second communications network MFN2, of which only two service computers AP1 and AP2 are illustrated, schematically. An instant messaging service runs on the service computer AP1 in this execution computer (that is to say an application, a computer program which makes it possible for the communications terminal KEG2 to transmit and to receive instant messaging messages). As soon as this instant messaging application has been started ST2 on the first service computer AP1 by means of the communications terminal KEG2 (that is to say as soon as the communications terminal KEG2 can be accessed via the instant message (IM)), this information is transmitted as a presence data item by means of the presence message PN2 to the presence computer PR.

The further communications terminal KEG3 in this exemplary embodiment starts ST3 an online game application on the second service computer AP2 (for example a computer program which allows various communications terminals to play online via the communications network MFN2). Since the further communications terminal KEG3 can be accessed via the online game after the time at which the program is started, and a communication link can be set up via the online computer game to the communications terminal KEG3, information relating to the start of the game program is transmitted as a presence data item by means of the presence message PN3 from the second communications network MFN2 to the presence computer PR. Presence messages such as these may also be sent directly from the further communications terminals via the mobile radio network MFN2 to the presence computer. All the presence data which reaches the presence computer is stored in it.

It should expressly be mentioned that the method according to the invention can be carried out not only using communications terminals which are connected to mobile radio networks but also using other communications terminals, for example landline communications terminals using landline communications networks. Thus, for example, it is also possible to use landline telephones or computers connected to the Internet as communications terminals.

The processes which are carried out in the presence computer PR will be explained in detail later with reference to FIGS. 2 to 5. When the request message ABN arrives, these processes result in user-specific presence display data PAD being sent from the presence computer to the list generating device LE. The list generating device LE uses the user-specific presence display data PAD to produce a list LI which is in a format which can be explained on the display unit A of the communications terminal KEG1. This list LI is transmitted via the switching center VST to the communications terminal KEG1, and is output on its display unit A.

When producing the presence display data PAD, the presence computer PR generates charging data VD which relates to the nature and scope of the presence display data PAD being produced, and makes it possible to charge the communications terminal KEG1, or the user NU1 of this communications terminal. In order to produce the charging data VD, the presence computer PR determines and records various features relating to the production of the presence display data PAD. In particular, it is possible to use the following items to produce the charging data VD:

the number and the scope of the presence information items determined for each call message ABN,

the type of applications used by the further communications terminals (for example the programs on the first service computer AP1 or on the second service computer AP2)

the amount of presence display data PAD

the type of the first communications terminal KEG1

the frequency of occurrence of new updated presence data items

the number of presence information items provided by the presence server for each further communications terminal.

These features, which are mentioned by way of example, are used by the presence computer PR to determine a charge amount which is charged to the communications terminal KEG1 or to the user of this communications terminal. In this case, the amount to be transmitted with the charging data VD can be determined by addition of individual charging amounts which are associated with each of the features mentioned above. Alternatively, a flat rate amount can be provided for provision of presence display data for use of the method, and this is produced and processed as the charging data VD.

In a first refinement of the method, the charging data VD is transmitted from the presence computer via the list generating device LE to the switching center VST in the first communications network MFN1. The switching center VST then produces charge tickets T associated with the charging data, and sends these to a charge invoicing device in the form of a postpaid invoice production device PP. Invoice production devices such as these are known per se in mobile telephone networks and are used to produce the billing or invoices, which can be sent out monthly for example, for the mobile telephone calls made. After receiving the charge tickets T, a charge invoicing device such as this can be used to produce the bill for the first communications terminal KEG1, for the service of providing the presence display data PAD.

In a second refinement, the charging data VD is sent via the switching center VST to the service switching point SSP in the first communications network MFN1, which is in the form of an intelligent network. The service switching point SSP starts a charge invoicing service in the service control point SCP associated with it, and sends the charging data VD to this service control point SCP. The service control point maintains a credit account GK which is associated with the first communications terminal KEG1 and causes the appropriate charge amount to be debited ABB from the credit account GK. The administration and maintenance of credit accounts in mobile radio networks is known per se, and is referred to as prepaid charge invoicing.

The processes which take place in the presence computer PR are explained in more detail in FIG. 2. The presence data PD which is transmitted to the presence computer PR by means of the presence messages PN1 to PN4 is stored such that it can be accessed via the presence computer by the presence data PD being stored in a presence data store PS in the presence computer, and being kept available there for further processing (in another exemplary embodiment, the presence data may, however, also be stored in a presence data store which is arranged outside the presence computer PR and which the presence computer can access by means of data checking messages. The presence data can also be stored in the distributed manner between two or more network nodes in a communications network). By way of example, the presence data (PD1 to PD6) is shown in the presence data store PS. Processing instructions V are stored in an instruction store VS, of which three processing instructions V1, V2 and V3 are shown by way of example. These processing instructions contain information relating to those processing steps which are intended to be carried out by a processing unit VE in order to produce presence display data PAD from the presence data PD; the processing instructions thus describe the type of processing. The processing instructions V are each associated with one user of the presence service, for example with the processing instruction V1 being associated with the first user NU1 shown in FIG. 1, the processing instruction V2 being associated with a further unit NU2, and the processing instruction V3 being associated with a third user NU3.

The first processing instruction V1 which is stored in the instruction store VS is now read from the instruction store VS and is transmitted to the processing unit VE. Depending on the instructions in the processing instruction V1, the processing unit VE reads the presence data items PD1, PD2 and PD3 from the presence data store PS and produces (in this example which is deliberately being kept simple) a first presence display data PAD, which contains only the stated presence data items PD1, PD2 and PD3. This way of processing the presence data PD is thus restricted to transferring (copying) the presence data from the presence data store to a presence display data record PAD1. The presence display data PAD1 is then stored in the display store AS. This process is repeated in an analogous manner with the second processing instruction V2; the processing unit VE now produces a data record with second presence display data items PAD2, containing the presence data items PD4, PD5 and PD6. Finally, third presence data items PAD3 are produced using the third processing instructions V3, and are likewise stored in the display store AS. Similar method steps are repeated in analogous manner for all those users who or which are taking part in the service of producing presence display data, and for whom or which presence data is being collected and presence display data is being produced.

If the communications terminal KEG1 illustrated in FIG. 1 for the user NU1 now requests presence information and the call message ABN then reaches the presence computer PR, user information which is contained in the call message is used to identify that the call message ABN is based on a request AN from the user NU1. The presence display data PAD1 (which has been produced using the processing instruction V1 associated with the first user) is now transmitted without any significant time delay to the list generating device LE in order to produce the appropriate list LI. Particularly when the production steps in the processing unit VE are time-consuming, the described method makes it possible to send the called presence display data PAD1 to the list generating device LE with scarcely any noticeable time delay, that is to say in real time. Assuming that a powerful list generating device is available, a list with the information from the presence display data PAD1 will reach the communications terminal KEG1 very quickly.

FIG. 3 shows a further exemplary embodiment of method steps which are carried out in the presence computer PR.

The presence data PD1 to PD6 in the presence data store PS is shown in this figure with values associated with it. The presence data item PD1 has the value 17, and the presence data item PD2 is allocated a value 23. The presence data item PD3 is in binary form, that is to say the presence data item PD3 may assume only the values “0” and “1”. The presence data item PD3 currently has the value “o”. The presence data item PD4 is also in binary form, and this presence data item can assume the two values “yes” and “no”; the presence data item PD4 currently has the value “yes”. The presence data item PD5 contains position details in the form of geographical longitudinal information “153 degrees”. The presence data item PD6 likewise has position details in the form of a number “10435” for a cell in a mobile radio network.

The aim of this exemplary embodiment is to describe how presence display data PAD3 is produced and is stored in the display store AS after a change to the presence data PD. Since the presence display data PAD3 is intended for a user NU3, the processing instruction V3 is read from the instruction store VS and is transported to the processing unit VE. The processing instruction V3 contains the information that the presence display data PAD3 contains four entries, which are formed in the following way:

The first component of the presence display data PAD3 is formed by the presence data PD1 which is transferred (copied) without being changed from the presence data store PS and is inserted into the data record PAD3.

The second component of the presence display data PAD3 is produced by the processing unit VE reading the presence data item PD3=0 from the presence data store. This presence data item PD3 is processed in such a way that the value “0” of the presence data item PD3 is inserted (with this inversion resulting in the value “1”). The presence data item PD3′=1 which has been changed in this way is inserted as a second component into the data record for the presence display data PAD3.

The third component of the presence display data PAD3 is produced by processing the presence data item PD6 in the presence data store PS. This presence data item PD6 has a value in the form of the information “cell 10435”. This is a cell in a mobile radio network in which a further communications terminal which has been monitored is currently located. Since this information in the presence data item PD6 is not very useful to a method user, this presence data item is changed during the processing in the processing unit VE. To do this, the processing unit VE accesses a database DS which, for example, is stored in a databank in the presence computer PR. The presence data item PD6 is compared with the collected presence data S-PD stored in the database DS. In this case, it is found that the value of the presence data item PD6 “cell 10435” is located within an area “cell 8563 to cell 14536” of the collected presence data S-PD, and this is therefore a positive comparison result. A positive comparison result such as this can thus occur, for example, when the presence data item is located within an area that is defined by the collected presence data S-PD (as shown in FIG. 3). A positive comparison result such as this can also occur when the presence data item matches a collected presence data item. This situation can occur in particular when the collected presence data S-PD includes an enumeration, a listing of individual data items. The collected presence data S-PD in the data store DS is associated with allocation data ZD in the form of a character chain “Berlin” (association Z1). This allocation data ZD is then read from the database DS and is transmitted as changed presence data PD6*=“Berlin” to the processing unit VE. The processing unit VE now stores this changed presence data item PD6* as a third entry in the data record of presence display data PAD3.

The fourth and final component of the presence display data PAD3 is produced by processing the presence data item PD2 in the presence data store PS. The presence data item PD2 is changed such that its value PD2=23 is replaced by a predetermined value PD2″=99, with this value PD2″=99 being read by the processing unit VE from a value store M. The presence data item PD2 is thus changed by replacing its value by a predetermined value 99. A predetermined value such as this or a presence data item can be associated, for example, with the user NU3 and can assume different values on a user-specific basis. A predetermined value such as this for a presence data item may, however, also assume a fixed, static magnitude, independently of the user.

This completes the processing of the presence data items PD1, PD3, PD6 and PD2 to form the presence display data PD3.

When a further core message ABN3 arrives from a communications terminal of the user NU3, presence display data PAD3 can now be sent to the list generating device LE without any time delay to this data record, in response to which this list generating device LE produces a further list LI in a known manner, and transmits this to the communications terminal of the user NU3.

The presence display data PAD is produced as soon as a change occurs in the presence data PD stored in the presence data store PS or a change occurs in the processing instructions V which are stored in the instruction store VS. All the processing instructions V in the instruction store VS are then used to produce all the presence display data items PAD by processing the presence data items PD which are currently in the presence data store PS, and this presence display data PAD can be produced from the presence data PD on the basis of the available processing instruction V. This ensures that all the presence display data which can be called by means of a call message ABN is always up to date in the display store AS.

In a further refinement of the method according to the invention, the only presence display data items PAD which are produced once again when a change occurs in the processing instructions or to the presence data is that which is directly affected by the change to (for example only one from a large number of) processing instructions or the change to one or more presence data items.

The following examples are intended to illustrate this: If the processing instruction V1 changes, then this change results only in the presence display data item PAD1 being produced once again and being stored once again in the display store AS, since the processing instruction V1 contains only instructions to produce the presence display data item PAD1.

If, however, the presence data item PD1 in the presence data store PS were to change, then new presence data items PAD1 would be produced by means of the processing instruction V1, since the presence data item PD1 is transferred to the presence display data PAD1 on the basis of the instruction V1. However, new presence display data items PAD3 are also produced using the processing instruction V3 and are stored once again in the display store AS, since the presence data item PD1 which has now been changed is also contained in the presence display data PAD3.

This means that the various presence display data items PAD1, PAD2 and PAD3 are always available in an up-to-date state in the display store AS and are available to be called up at any time by any of the existing processing instructions V1 to V3.

A further exemplary embodiment of the method is described in FIG. 4, in which three processing instructions V21, V22 or V23 are stored in the instruction store VS, and all three of them are associated with a user NU2. Each of the three processing instructions V21, V22 and V23 contains instructions for producing a presence display data record PAD2 for the user NU2. Each of these three processing instructions has an associated identifier K1, K2 and K3, with these identifiers K1, K2 and K3 each having different values. In the example, the processing instruction V21 is allocated an identifier K1=5, the processing instruction V22 is allocated an identifier K2=3, and the processing instruction V23 is allocated an identifier K3=7.

The identifiers K1, K2 and K3 describe the status of a subscriber, in this case the status of the subscriber T2, with whom or which the further communications terminal KEG2 is associated (see FIG. 1). The subscriber identifier K1=5 means that the subscriber T2 is at his workstation; his subscriber station is thus “at work”. The identifier K2=3 represents a situation in which the subscriber T2 together with his communications terminal KEG2 is at home, and his currently applicable subscriber station is thus “not at work”. The identifier K3=7, finally, represents a status “meeting—please do not disturb”. In this status, the subscriber T2 is in a meeting at work, and is not accessible.

The status that a subscriber is in may also be referred to as a “presence context” or a “subscriber context”.

Specifically, in a generalized form, this status contains information about the “presence” and the capability to access the subscriber for communication.

The currently applicable status for the subscriber T2 at the moment is in this exemplary embodiment transmitted from the further communications terminal KEG2 of the subscriber K2 to the presence computer PR by transmitting a subscriber identifier TK, which assumes the value TK=3, via the second mobile radio network MFN2 to the presence computer PR. The subscriber identifier TK=3 has previously been entered, for example, by the subscriber T2 on the keypad for the communications terminal KEG2.

This subscriber identifier TK=3 is received by the presence computer PR and is temporarily stored in a subscriber identifier store TKS in the presence computer PR. The value of the subscriber identifier TK=3 is compared with the identifier for the various processing instructions V21, V22 and V23 to determine the processing instruction which corresponds to that subscriber identifier (in this case the processing instruction V22 with the identifier K2=3), and this is transmitted to the processing device VE. The processing device then uses the instruction V22 in a known manner to produce the presence display data PAD2, and to store this in the display store AS.

Two or more processing instructions (which are associated with different users) may also have the same identifier. For example, using the notation in FIG. 4, it would be possible to have the processing instructions V11 for the user NU1, V31 for the user NU3 and V43 for the user NU4, all of whom have an identifier with the value “5”.

The currently applicable subscriber status as described by the subscriber identifier TK can also be referred to as the “role” of the subscriber. Thus, at this particular time, the subscriber is either in the role of an employee in his office, in the role of a private person who is spending his free time at home, or is in the role of a participant in a meeting who should not be disturbed by incoming communication attempts.

FIG. 5 shows a further possible way in which the subscriber identifier TK can be determined by the presence computer PR on the basis of the presence data PD. This is done by storing change rules in the change store AES in the presence computer PR, containing information that a predetermined change to a predetermined presence data item identifies a predetermined subscriber status and, in consequence, the subscriber identifier is set to a predetermined value. In the exemplary embodiment shown in FIG. 5, a change rule is stored in the change store AES which has the following form:

“PD3 0-->1: TK=3: PD2:=24”

This change rule contains the information that the presence data PD3 is to be monitored for a change from the value PD3=0 to the value PD3=1; if a change such as this occurs in the presence data PD3, then the subscriber identifier TK3 should be set to the value TK=3. The meaning of the expression “PD2:=24” will be explained further below. The presence computer PR thus automatically monitors UE the presence data PD3 to determine whether and when a subscriber status occurs which is identified by the subscriber identifier TK=3. When this change to be monitored for occurs, the subscriber identifier is set to the value TK=3, and the corresponding value TK=3 is stored in the subscriber identifier store TKS. The rest of the procedure corresponds to the procedure described in conjunction with FIG. 4.

The part “PD2:=24” of the change rule in the change AES which has already been mentioned above contains the information that the presence data PD2 should be set to the value 24 when the subscriber identifier TK=3 occurs. This means that individual presence data items are changed when a new up-to-date subscriber status is identified for that subscriber. In consequence, the presence data PD can be matched to the new situation immediately after identification of the new subscriber status and setting of the new subscriber identifier TK.

In a practical exemplary embodiment relating to this, as soon as a subscriber changes to the “not at work” role, this subscriber is no longer accessible via his office telephone but via his private telephone. This change to the telephone accessibility may, for example, be registered by changing the presence data PD2. Since—as mentioned above—the presence display data is automatically produced once again after every change to the presence data, the presence display data PAD relating to this new information is updated immediately and is available to be called in the display store AS.

The change to the presence data PD3 from the value 0 to the value 1 which initiated the identification of the new subscriber station and the setting of the new subscriber identifier can in this exemplary embodiment be caused, for example, by the subscriber having logged on on his computer at home; this information was transmitted as presence data PD3 by means of the presence message PN3 to the presence computer.

In the described exemplary embodiments of the method, the processing instructions V1, V2 and V3 can each be associated not just with a single user but also with a group of users. Even if there are a large number of service users, grouping of these users (for example in three user groups NU1′, NU2′ and NU3′ as would occur instead of the user NU1, NU2 and/or NU3) allows the number of processing instructions required to be kept small.

1. A method for providing presence display data (PAD1), which is associated with a user (NU1) for display on a communications terminal (KEG1), in which
presence data (PD) which relates to at least one preselected subscriber is stored such that it can be accessed by a presence computer (PR),
the presence display data (PAD1) is produced with the presence data (PD) being processed on the basis of a processing instruction (V1) which is associated with the user (NU1), and
the presence display data (PAD1) is stored in a display store (AS), as a result of which the presence display data (PAD1) can be transmitted to the communications terminal (KEG1) immediately after being read from the display store (AS) when a check (AN, ABN) is made at the communications terminal (KEG1) end.

2. The method as claimed in claim 1, characterized in that
the processing comprises the transfer of selected presence data (PD1, PD2, PD3) to the presence display data (PAD1).

3. The method as claimed in claim 1, characterized in that
the processing comprises the changing of selected presence data (PD3, PD6) and the transfer of changed presence data (PD3′, PD6*) to the presence display data (pad3).

4. The method as claimed in claim 3, characterized in that
the presence data (PD6) is changed by
comparing the presence data (PD6) with collected presence data (S-PD) which is stored in a database (DS), and
if the result of the comparison is positive, by using allocation data (ZD), which is associated (Z1) with the collection presence data (S-PD), as the changed presence data (PD6*).

5. The method as claimed in claim 3, characterized in that
the presence data is changed by inverting (′) presence data (PD3) which is in binary form, and
by using the inverted presence data (PD3′) as the changed presence data.

6. The method as claimed in claim 3, characterized in that
the presence data is changed by replacing presence data (PD2) by predetermined presence data (PD2″=99), and
by using the predetermined presence data (PD2″) as the changed presence data.

7. The method as claimed in claim 1, characterized in that
the presence display data (PAD) is produced when a change occurs in the presence data (PD) which is stored for the presence computer (PR).

8. The method as claimed in claim 1, characterized in that
the presence display data (PAD) is produced when a change occurs to the processing instructions (V) which are stored in an instruction store (VS).

9. The method as claimed in claim 1, characterized in that
two or more different presence display data items (PAD1, PAD2, PAD3) are produced on the basis of two or more processing instructions (V1, V2, V3), with each of these processing instructions (V1, V2, V3) being associated with one user (NU1, NU2, NU3), and
these two or more presence display items (PAD1, PAD2, PAD3) are stored in a display store (AS).

10. The method as claimed in claim 1, characterized in that
various processing instructions (V21, V22, V23) for a user (NU2) are stored in the instruction store (VS), and
the single processing instruction (V22) which is currently to be used is determined from these various processing instructions (V21, V22, V23) by comparing identifiers (K1, K2, K3) which are in each case different and are associated with the various processing instructions (V21, V22, V23) with a subscriber identifier (TK) which is available in the presence computer (PR) and describes a currently applicable subscriber status of that subscriber.

11. The method as claimed in claim 10, characterized in that
the subscriber identifier (TK) is received at the presence computer (PR) end by a presence communication terminal (KEG2) for the subscriber, and the subscriber identifier (TK) can be entered on the presence communications terminal (KEG2).

12. The method as claimed in claim 10, characterized in that
the subscriber identifier (TK) is determined by the presence computer (PR) by monitoring (UE) a predetermined presence data item (PD3) for a predetermined change (0→1), and by identifying the presence of the subscriber identifier (TK=3) when this change occurs.

13. The method as claimed in claim 10, characterized in that
once the presence computer (PR) has determined the subscriber identifier (TK=3), presence data (PD2) which is associated with that subscriber identifier is changed (PD2:=24), in response to which the presence display data (PAD22) is produced once again.
